(19) United States
(12) Patent Application Publication
(10) Pub. No.: US 2012/0049396 A1
(43) Pub. Date: Mar. 1, 2012

(54) PATTERN FORMING METHOD AND PATTERN FORMING DEVICE

(76) Inventors: Tomohiro Tsutsui, Tokyo (JP); Osamu Ikenaga, Yokohama-shi (JP); Ryoichi Inanami, Yokohama-shi (JP)

(21) Appl. No.: 13/217,698

(22) Filed: Aug. 25, 2011

(30) Foreign Application Priority Data
Aug. 25, 2010 (JP) 2010-188663

(51) Int. Cl. B29C 59/02

(52) U.S. Cl. 264/40.1; 425/135

(57) ABSTRACT

According to one embodiment, a pattern forming method includes transferring a first pattern area of a plurality of pattern areas to a to-be-processed substrate, by using a template on which the plurality of pattern areas, where patterns are formed on a substrate, are disposed, counting up a number of times of transfer of the first pattern area, and storing the number of times of transfer, determining whether the stored number of times of transfer of the pattern of the first pattern area has exceeded a specified number, and executing switching to a second pattern of the plurality of pattern areas when it is determined, at a time of the determining, that the stored number of times of transfer of the pattern of the first pattern area has exceeded the specified number, and transferring the second pattern area to the to-be-processed substrate.

### CROSS-REFERENCE TO RELATED APPLICATIONS

This application is based upon and claims the benefit of priority from prior Japanese Patent Application No. 2010-188663, filed Aug. 25, 2010, the entire contents of which are incorporated herein by reference.

### FIELD

Embodiments described herein relate generally to a pattern forming method and a pattern forming device.

### BACKGROUND

Templates for nano-imprint, which are used in nano-imprint technologies, include a template which is fabricated by using a quarts plate of a 6-inch size.

The template has such a structure that one pattern corresponding, at 1:1, to a pattern, which is to be formed on a silicon (Si) substrate, is disposed at the center of the quartz substrate.

By pressing this template on the Si substrate, a desired pattern is formed on the Si substrate. However, in the case where some problem, such as contamination or a flaw on the pattern, has occurred on the template during the use of the replica template, or before or after the use of the replica template, it becomes impossible to continuously use this template and it becomes necessary to replace this template with another template. As a result, there is a tendency that a response time (hereinafter referred to as TAT (turn around time)) degrades.

### BRIEF DESCRIPTION OF THE DRAWINGS

FIG. 1 is a block diagram showing a structure example of a pattern forming device according to a first embodiment;

FIG. 2 shows a replica template which is used in the pattern forming device according to the first embodiment;

FIG. 3 is a flow chart illustrating a pattern forming method according to the first embodiment;

FIG. 4 is a cross-sectional view for describing one step of the pattern forming method according to the first embodiment;

FIG. 5 shows a Si substrate after pattern transfer (formation by S101 alone) according to the first embodiment;

FIG. 6 shows a Si substrate after pattern transfer (formation by S101 and other area) according to the first embodiment;

FIG. 7 shows a replica template which is used in a pattern forming device according to a second embodiment;

FIG. 8 is a flow chart illustrating a pattern forming method according to the second embodiment;

FIG. 9 shows a Si substrate after pattern transfer (pattern “F”) according to the second embodiment;

FIG. 10 shows a Si substrate after pattern transfer (pattern “A”) according to the second embodiment;

FIG. 11 shows a replica template according to a comparative example; and

FIG. 12 is a cross-sectional view for describing one step of the pattern forming method according to the comparative example.

### DETAILED DESCRIPTION

In general, according to one embodiment, a pattern forming method includes transferring a first pattern area of a plurality of pattern areas to a to-be-processed substrate, by using a template on which the plurality of pattern areas, where patterns are formed on a substrate, are disposed; counting up a number of times of transfer of the first pattern area, and storing the number of times of transfer; determining whether the stored number of times of transfer of the pattern of the first pattern area has exceeded a specified number; and executing switching to a second pattern of the plurality of pattern areas when it is determined, at a time of the determining, that the stored number of times of transfer of the pattern of the first pattern area has exceeded the specified number, and transferring the second pattern area to the to-be-processed substrate.

Embodiments will now be described with reference to the accompanying drawings. In the description below, common parts are denoted by like reference numerals throughout the drawings.

### First Embodiment

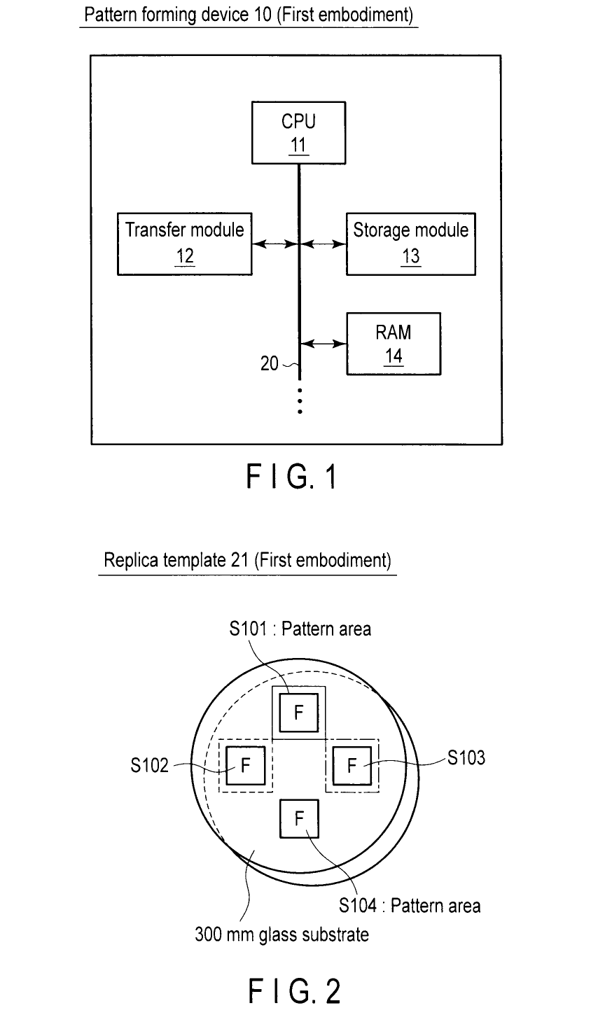

To begin with, referring to FIG. 1 to FIG. 6, a pattern forming method and a pattern forming device according to a first embodiment are described.

### <1. Structure Example>

### 1-1. Pattern Forming Device

Referring to FIG. 1, a description is given of a structure example of the pattern forming device which executes the pattern forming method according to the embodiment.

As shown in FIG. 1, a pattern forming device 10 according to the embodiment comprises a CPU 11, a transfer module 12, a storage module 13 and a RAM 14.

The CPU (central processing unit) 11 functions as a control module which controls the above-described structural components and controls the entire operation for executing the pattern forming method which will be described later. To be more specific, for example, the CPU 11 determines whether the number of times of pattern transfer of a pattern area S101, which is stored in the storage module 13, has exceeded a preset specified number of times. Further, when the number of times of pattern transfer has exceeded the specified number of times, the CPU 11 controls the transfer module 12 so as to switch the pattern area 5101 to a pattern area 5103 of a plurality of pattern areas and to transfer the second pattern area S103 to a Si substrate (e.g., Si wafer) 31.

In the pattern forming method which will be described later, the transfer module 12, under the control of the CPU 11, transfers a predetermined shot pattern, which is selected in a replica template 21, to a silicon substrate which is a to-be-processed substrate.

In the pattern forming method that will be described later, the storage module 13, under the control of the CPU 11, stores a counted-up number of times of transfer of a pattern area. For example, a magnetic storage medium such as an HDD (hard disk drive), or a semiconductor storage medium such as a NAND flash memory can be applied to the storage module 13, where necessary.

The RAM 14 temporarily stores, for example, a control program which is necessary for executing the pattern forming method of the embodiment. Thus, the control program for executing the pattern forming method which is described later is developed on the RAM 14.

The above-described structural components are electrically connected by a bus 20.

The pattern forming device, which is shown, is merely an example, and the pattern forming device is not limited to this example. Modifications may properly be made, where necessary.

### 1-2. Replica Template

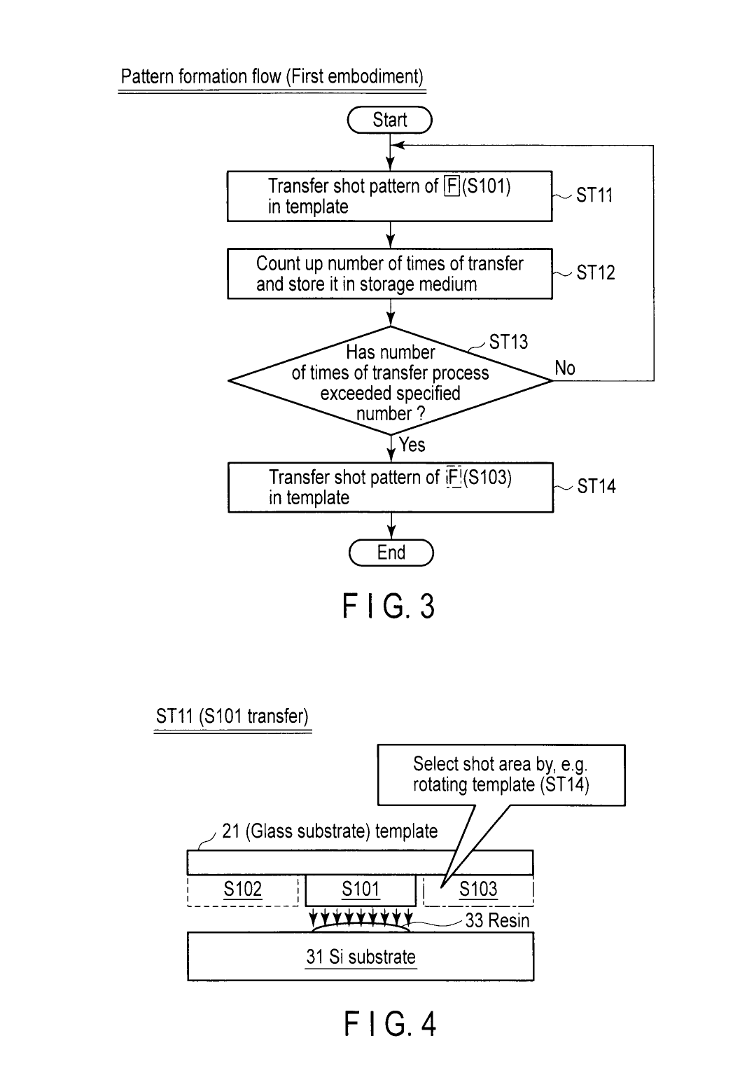

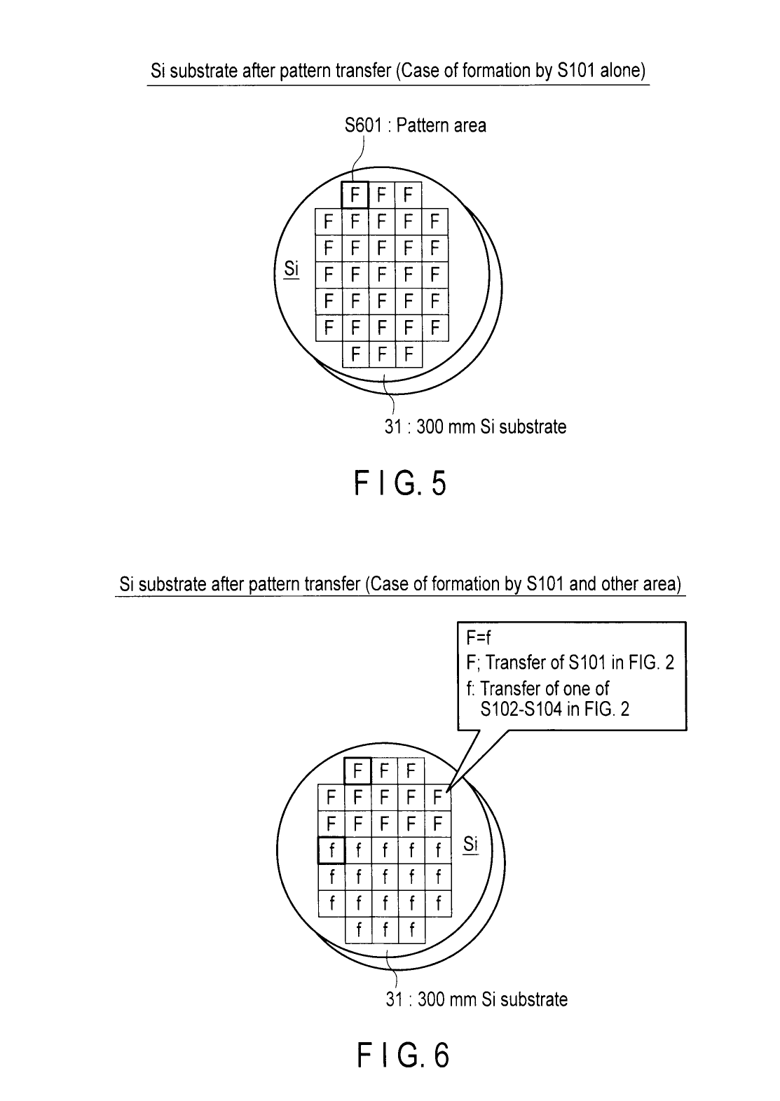

Next, referring to FIG. 2, a description is given of a replica template which is used in the pattern forming method of the present embodiment. In the pattern forming device 10, the replica template 21 is disposed in the transfer module 12 so as to be opposed to a silicon (Si) substrate that is a to-be-processed substrate.

As shown in FIG. 2, a plurality of pattern areas (S101 to S104), in which patterns (illustrated as “F”) are formed, are disposed on the substrate.

In the present embodiment, a glass substrate with a diameter of 300 mm is used as an example of the substrate.

The plural pattern areas (S101 to S104) are disposed on the 300 mm glass substrate. The patterns that are represented by “F” in the plural patterns (S101 to S104) are subjected to pattern processing which is necessary for transferring, in a pattern forming method (to be described later), the patterns “F” on the silicon (Si) substrate that is coated with a resin, by pressing the template 21 on the silicon (Si) substrate. The four patterns “F” in the pattern areas (S101 to S104) can be formed on the glass substrate by using an ordinary technique.

In this case, the description is given by assuming that the plural shot patterns formed in the replica template 21 are all the same design pattern (“F”). In addition, it is assumed that the size of the shot pattern in each of the pattern areas (S101 to S104) corresponds, at a ratio of 1:1, to the size of each of the shot patterns that are formed on the Si substrate.

In the present embodiment, the size of the shot pattern formed on the replica template 21 is the same as the size of the shot pattern formed on a replica template 210 using a 6-inch glass substrate according to a comparative example which will be described with reference to FIG. 11.

Although not shown in the Figures, the pattern area (S101 to S104) includes an alignment mark. The alignment mark is used in order to align a to-be-processed substrate just under the pattern (S101 to S104) of the template 21 in the pattern forming method that will be described later. In addition, in the embodiment, the number of shot patterns in the replica template is set to be four by way of example. However, the number of shot patterns is not limited to four.

### <2. Pattern Forming Method>

### 2-1. Pattern Formation Flow

Next, the pattern forming method according to the present embodiment is described with reference to a flow shown in FIG. 3.

### (Step ST11)

To start with, the transfer module 12 transfers the shot pattern (“F”) in the pattern area S101 of the template 21, which is surrounded by a solid line as illustrated in FIG. 3, to the silicon (Si) substrate that is the to-be-processed substrate.

The template 21 and the to-be-processed substrate in step ST11 are as shown in FIG. 4. As shown in FIG. 4, in step ST11, alignment is executed such that a resin 33 of the silicon (Si) substrate 31 that is the to-be-processed substrate is disposed just under the pattern area 5101 of the template 21. At the time of the alignment, the alignment mark (not shown), which is formed on the pattern area S101, is used. The resin 33 is coated on a desired pattern formation area on the Si substrate 31.

The pattern area 5101 is pressed on the resin 33 of the Si substrate 31. Thereby, the shot pattern “F” in the pattern area 5101 is transferred to the desired pattern formation area on the Si substrate 31.

### (Step ST12)

Subsequently, the CPU 11 counts up the number of times of transfer, and stores the number of times of transfer in the storage module 13 such as a magnetic storage device.

### (Step ST13)

Then, the CPU 11 determines whether the number of times of transfer of the pattern of the pattern area S101, which is stored in the storage module 13, has exceeded a preset specified number.

In step ST13, if it is determined that the number of times of transfer has not exceeded the specified number (No), the shot pattern “F” of the pattern formation area S101 is similarly selected and transferred to a desired pattern position on the Si substrate 31. This operation is repeated by a number of times, which corresponds to the number of shot patterns which are transferred to the Si substrate 31.

### (Step ST14)

Then, in step ST13, if it is determined that the number of times of transfer has exceeded the specified number (Yes), the transfer module 12 transfers to the silicon (Si) substrate 31, which is the to-be-processed substrate, a shot pattern of a pattern formation area which is different from the selected pattern formation area 101, or, in this example, a shot pattern (“F”) of the pattern area 5103 surrounded by a dot-and-dash line in the template 21.

The template 21 and the to-be-processed substrate in step ST14 are as shown in FIG. 4. As shown in FIG. 4, if it is determined that the number of times of transfer has exceeded the specified number, the template 21 is rotated, and alignment is executed such that the resin 33 of the silicon (Si) substrate 31 that is the to-be-processed substrate is disposed just under the selected pattern area S103.

Similarly, the pattern area S103 of the template 21, which is different from the pattern area S101, is pressed on the resin 33 of the Si substrate 31. Thereby, the shot pattern “F” in the pattern area S103 is transferred to the desired pattern formation area on the Si substrate 31.

2-2. Si Substrate after Pattern Formation (only S101)

FIG. 5 shows a finished 300 mm Si substrate 31 after the pattern transfer by the above-described flow with use of the replica template 21 according to the present embodiment.

FIG. 5 shows the case in which the shot patterns “F”, which have been transferred to the Si substrate 31, are all formed by the pattern area 5101 of the template 21. In other words, the Si substrate 31 shown in FIG. 5 exemplifies the case in which it is determined in step ST13 that the number of times of transfer has not exceeded the specified number and only the shot pattern “F” of the pattern formation area S101 has been transferred to desired pattern positions on the Si substrate 31 by the number of times corresponding to the number of shot patterns.

2-3. Si Substrate after Pattern Formation (S101 and other Area, S102-S104)

FIG. 6 shows a finished 300 mm Si substrate 31 after the pattern transfer by the above-described flow with use of the replica template 21 according to the present embodiment. The case of FIG. 6 differs from the case of FIG. 5 in that the patterns are formed by the pattern area 5101 and other pattern areas S102 to S104.

As shown in FIG. 6, areas, where patterns have been transferred to the Si substrate 31 by the pattern area S101, are indicated by “F”, and areas, where patterns have been transferred to the Si substrate 31 by other pattern areas S101 to S104, are indicated by “f” (actually, f=F). In other words, the Si substrate 31 shown in FIG. 6 exemplifies the case in which it is determined in step ST13 that the number of times of transfer has exceeded the specified number and the shot patterns “f (=F)” of the pattern formation areas S101 to S104 have been transferred to desired pattern positions on the Si substrate 31 by the number of times corresponding to the number of shot patterns. In this manner, if the number of times of transfer has exceeded the specified number while the patterns are being transferred to the same Si substrate 31, a plurality of shot patterns in the replica template 21 are needed.

In the case where some problem, such as contamination or a flaw on the pattern, has occurred on the template during the use of the replica template, or before or after the use of the replica template, it becomes impossible to continuously use this template.

As a result, as in the comparative example which will be described later, it becomes necessary to replace this template with another template, and a response time (hereinafter referred to as TAT (turn around time)) degrades.

However, in the replica template 21 according to the present embodiment, the plural areas 5101 to S104 having the same shot pattern “F” are disposed on the glass substrate.

Thus, when some problem has occurred during the use of the replica template, it is determined that the number of times of transfer has exceeded the specified number (ST13) and then the pattern area is switched to some other pattern area, S102 to S104, in the same template 21, thus being able to transfer the pattern “f” (step ST14).

As a result, the same patterns as in the case (FIG. 5) of transferring the same shot pattern of the replica template 21 can be transferred to the finished Si substrate 31 shown in FIG. 6, without degrading the TAT.

### <3. Advantageous Effects>

According to the pattern forming method and pattern forming device of the first embodiment, at least the following advantageous effects (1) and (2) can be obtained.

### (1) The TAT (Turn Around Time) can Advantageously be Improved.

As has been described above, in the replica template 21 according to the present embodiment, the plural areas 5101 to S104 having the same shot pattern “F” are disposed on the glass substrate.

Thus, when some problem has occurred during the use of the replica template, it is determined that the number of times of transfer has exceeded the specified number (ST13) and then the pattern area is switched to some other pattern area, S102 to S104, in the same template 21, thus being able to transfer the same pattern “F” (step ST14).

To be more specific, in the above-described step ST13, if it is determined that the number of times of transfer has exceeded the specified number (Yes), the transfer module 12 transfers to the silicon (Si) substrate 31, which is the to-be-processed substrate, a shot pattern of a pattern formation area which is different from the selected pattern formation area 101, or, in this example, a shot pattern (“F”) of the pattern area 5103 surrounded by a dot-and-dash line in the template 21.

The template 21 and the to-be-processed substrate in step ST14 are as shown in FIG. 4. As shown in FIG. 4, if it is determined that the number of times of transfer has exceeded the specified number, the template 21 is rotated, and alignment is executed such that the resin 33 of the silicon (Si) substrate 31 that is the to-be-processed substrate is disposed just under the selected pattern area 5103. Then, the pattern area S103 of the template 21, which is different from the pattern area 5101, is pressed on the resin 33 of the Si substrate 31. Thereby, the shot pattern “F” in the pattern area S103 is transferred to the desired pattern formation area on the Si substrate 31. For example, the Si substrate 31 after the pattern transfer is as shown in FIG. 6, like the case (FIG. 5) in which the single pattern area S101 is used.

As has been described above, according to the pattern forming method and pattern forming device of the present embodiment, even in the case where some problem has occurred on the template during the use of the replica template, or before or after the use of the replica template, it is unnecessary to replace the template with another template, unlike the comparative example which will be described later. As a result, the TAT (turn around time) can advantageously be improved.

### (2) The Manufacturing Cost can Advantageously be Decreased.

In the replica template 21 according to the present embodiment, it should suffice if the same shot pattern is formed in the plural pattern areas 5101 to S104 on the glass substrate by using an ordinary technique. The merit of manufacturing the template 21 of the glass substrate with the size of 300 mm is that the existing equipment, such as a processing device, a measuring device and a washing device, which are used in “Si-Fab”, for example, can directly be used. Since a new investment is needless, the cost of the investment in equipment can be reduced.

To be more specific, in the pattern forming device 10 shown in FIG. 1, for example, an expensive exposure device is needless. Meantime, nanometer (nm)-level patterns “F” can be formed on the silicon substrate 31 which is coated with the resin 33 as described above.

As has been described above, according to the pattern forming method and pattern forming device of the present embodiment, the manufacturing cost can advantageously be reduced.

### Second Embodiment

### An Example in which a Plurality of Different Design Patterns are Disposed

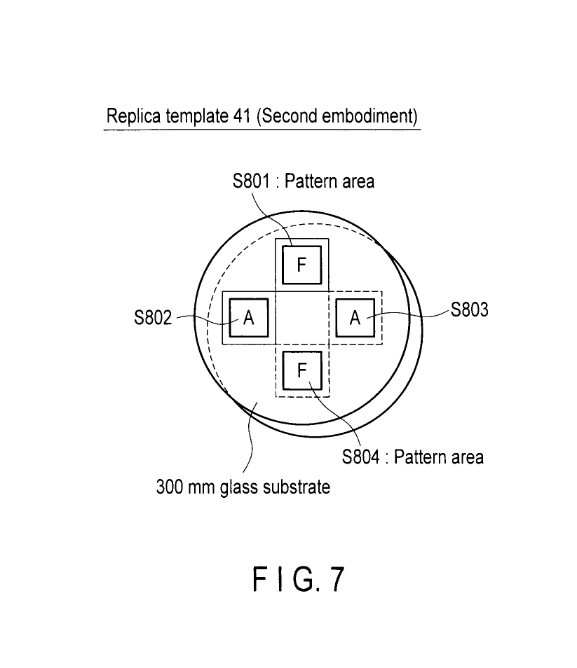

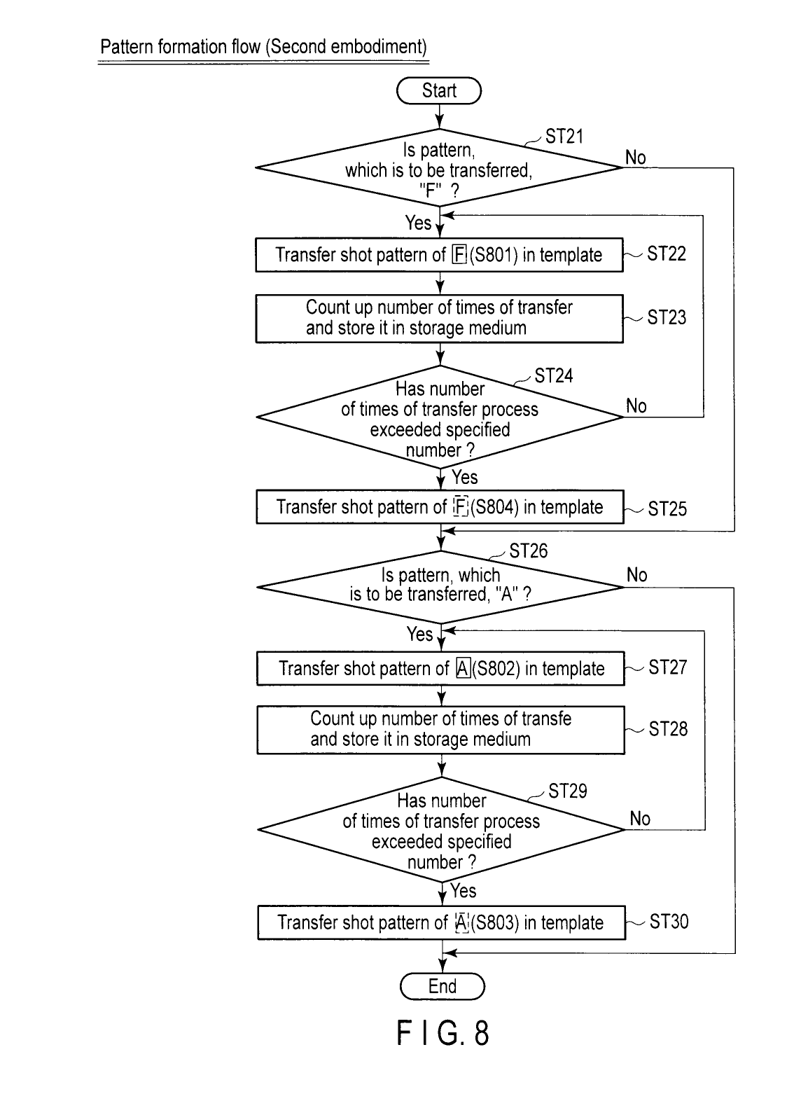

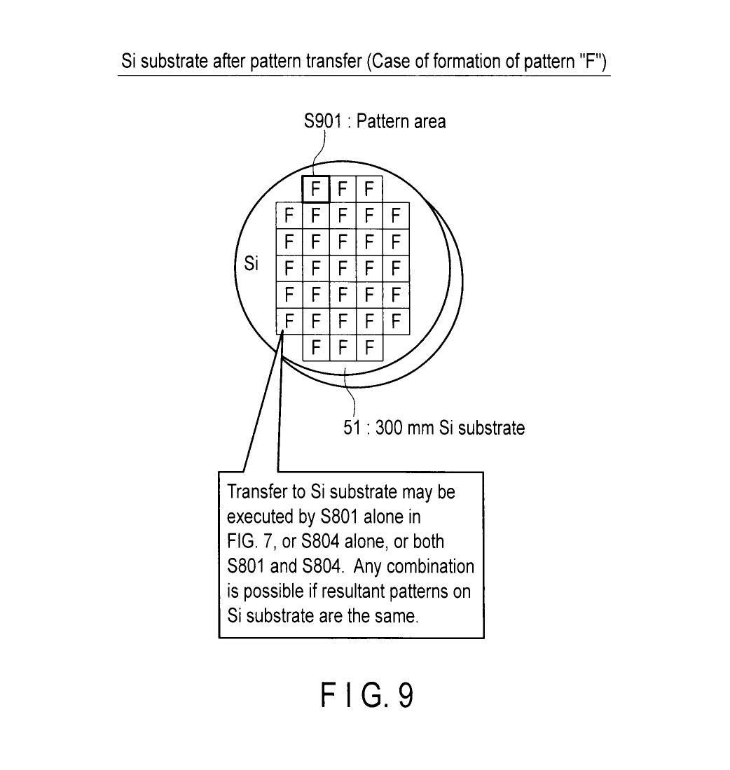

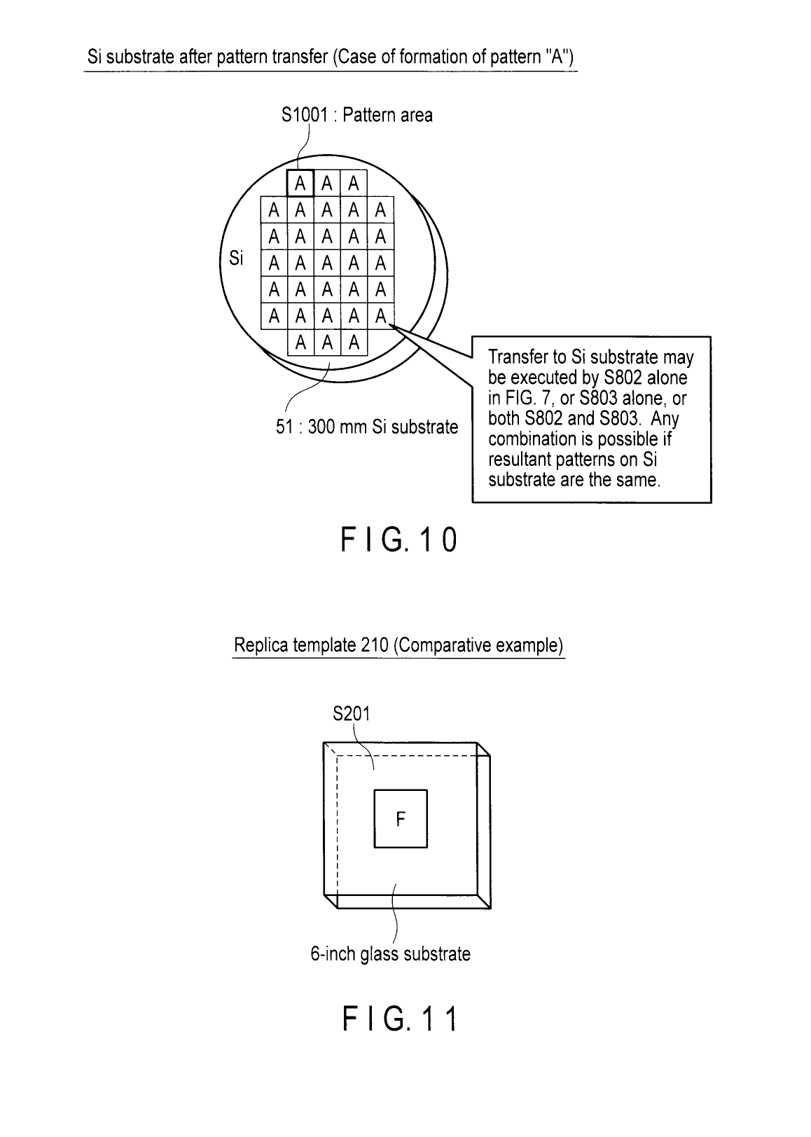

Next, referring to FIG. 7 to FIG. 10, a pattern forming method and a pattern forming device according to a second embodiment are described. This embodiment relates to an example in which a plurality of different design patterns are disposed on the template. A detailed description of the parts, which are common to the parts in the first embodiment, is omitted.

### <Structure Example>

### Structure Example of Replica Template

To begin with, referring to FIG. 7, a description is given of a structure example of a replica template 41 which is used in the pattern forming method of the second embodiment. In the above-described pattern forming device 10, the replica template 41 is disposed in the transfer module 21 so as to face the silicon (Si) substrate that is the to-be-processed substrate.

As shown in FIG. 7, the replica template 41 of the present embodiment differs from the replica template of the above-described first embodiment in that a plurality of different design patterns “A (≠)” are disposed in pattern areas S802 and S803 on the template 41.

Like the first embodiment, a glass substrate with a diameter of 300 mm is used as the material of the replica template 41. The same patterns “F” as described above are formed in pattern areas S801 and S804 in FIG. 7. In this manner, in the present embodiment, the shot patterns, which are disposed on the replica template 41, are patterns of two different designs, such as “F” and “A”.

The size of each of the shot patterns “F” and “A” of the pattern areas S801 to S804 corresponds, at a ratio of 1:1, to the size of each of the shot patterns which are formed on the Si substrate that is the to-be-processed substrate. In other words, the size of each of the shot patterns “F” and “A”, which are formed on the replica template 41 in the second embodiment, is the same as the size of the shot pattern formed on the replica template 210 using a 6-inch glass substrate according to the comparative example which will be described later. Although not shown in the Figures, the pattern areas 5801 to 5804 include alignment marks.

In the embodiment, two kinds of design patterns “F” and “A” are illustrated by way of example. However, the number of kinds of design patterns is not limited to this example. A greater number of kinds of shot patterns may be combined.

### <Pattern Forming Method>

Next, the pattern forming method according to the second embodiment is described with reference to a flow shown in FIG. 8.

### (Step ST21)

To start with, as shown in FIG. 8, it is determined whether the pattern, which is to be transferred to the 300 mm Si substrate, is the “F” that is disposed in the pattern area S801, S804. In step ST21, if it is determined that the pattern that is to be transferred is not the “F” (No), the process advances to step ST26.

### (Step ST22)

In step ST21, if the pattern which is to be transferred is the “F” (Yes), the transfer module 12 transfers the shot pattern “F” in the pattern area 5801 of the template 41, which is surrounded by a solid line, to the silicon (Si) substrate that is the to-be-processed substrate.

The template 41 and the to-be-processed substrate in step ST22 are the same as shown in FIG. 4. In step ST22, alignment is executed such that the resin of the silicon (Si) substrate that is the to-be-processed substrate is disposed just under the pattern area S801 in the template 41. At the time of the alignment, the above-described alignment mark, which is formed on the pattern area 5801, is used. The pattern area S801 is pressed on the resin of the Si substrate. Thereby, the shot pattern “F” in the pattern area S801 is transferred to the desired pattern formation area on the Si substrate.

### (Step ST23)

Subsequently, the CPU 11 counts up the number of times of transfer of the pattern “F” in the pattern area 5801, and stores the number of times of transfer in the storage module 13 such as a magnetic storage device.

### (Step ST24)

Then, the CPU 11 determines whether the number of times of transfer of the pattern of the pattern area S801, which is stored in the storage module 13, has exceeded a preset specified number.

In step ST24, if it is determined that the number of times of transfer has not exceeded the specified number (No), the shot pattern “F” of the pattern formation area 5801 is similarly selected and transferred to a desired pattern position on the Si substrate. This operation is repeated by a number of times, which corresponds to the number of shot patterns which are transferred to the Si substrate.

### (Step ST25)

Then, in step ST24, if it is determined that the number of times of transfer has exceeded the specified number (Yes), the transfer module 12 transfers to the silicon (Si) substrate, which is the to-be-processed substrate, a shot pattern of a pattern formation area which is different from the selected pattern formation area 801, or, in this example, a shot pattern (“F”) of the pattern area 5804 surrounded by a broken line in the template 41.

The template 41 and the to-be-processed substrate in step ST25 are as shown in FIG. 4. In step S25, if it is determined that the number of times of transfer has exceeded the specified number, the template 41 is rotated, and alignment is executed such that the resin of the silicon (Si) substrate that is the to-be-processed substrate is disposed just under the selected pattern area 5804. Similarly, the pattern area S804 of the template 41, which is different from the pattern area S801, is pressed on the resin of the Si substrate. Thereby, the shot pattern “F” in the pattern area 5804 is transferred to the desired pattern formation area on the Si substrate.

### (Step ST26)

Following the above, it is determined whether the pattern, which is to be transferred to the Si substrate, is the “A” that is disposed in the pattern area S802, S803. In step ST26, if it is determined that the pattern that is to be transferred is not the “A” (No), the pattern formation operation is completed (End).

### (Step ST27)

In step ST26, if the pattern which is to be transferred is the “A” (Yes), the transfer module 12 transfers the shot pattern “A” in the pattern area S802 of the template 41, which is surrounded by a solid line, to the silicon (Si) substrate that is the to-be-processed substrate.

The template 41 and the to-be-processed substrate in step ST27 are the same as shown in FIG. 4. As a result, the shot pattern “A” in the pattern area S802 is similarly transferred to the desired pattern formation area on the Si substrate.

### (Step ST28)

Subsequently, the CPU 11 counts up the number of times of transfer of the pattern “A” in the pattern area 5802, and stores the number of times of transfer in the storage module 13 such as a magnetic storage device.

### (Step ST29)

Then, the CPU 11 determines whether the number of times of transfer of the pattern of the pattern area S802, which is stored in the storage module 13, has exceeded a preset specified number.

In step ST29, if it is determined that the number of times of transfer has not exceeded the specified number (No), the shot pattern “A” of the pattern formation area S802 is similarly selected and transferred to a desired pattern position on the Si substrate. This operation is repeated by a number of times, which corresponds to the number of shot patterns which are transferred to the Si substrate.

### (Step ST30)

Then, in step ST29, if it is determined that the number of times of transfer has exceeded the specified number (Yes), the transfer module 12 transfers to the silicon (Si) substrate, which is the to-be-processed substrate, a shot pattern of a pattern formation area which is different from the selected pattern formation area 802, or, in this example, a shot pattern (“A”) of the pattern area S803 surrounded by a broken line in the template 41.

The template 41 and the to-be-processed substrate in step ST30 are as shown in FIG. 4. In step S30, if it is determined that the number of times of transfer has exceeded the specified number, the template 41 is rotated, and alignment is executed such that the resin of the silicon (Si) substrate that is the to-be-processed substrate is disposed just under the selected pattern area S803. Similarly, the pattern area S803 of the template 41, which is different from the pattern area S802, is pressed on the resin of the Si substrate. Thereby, the shot pattern “A” in the pattern area 5803 is transferred to the desired pattern formation area on the Si substrate. This operation is repeated by a number of times, which corresponds to the number of shot patterns which are transferred to the Si substrate, and this operation is completed (End).

In the second embodiment, the switching and selection of the pattern area in the order of “pattern area S801→S804” has been illustrated by way of example (ST22 to ST25). Alternatively, the pattern may be switched and selected in the order of “pattern area S804→S801”. Likewise, the pattern may be switched and selected not in the order of “pattern area S802→S803”, but in the order of “pattern area S803→S802”.

Si Substrate after Pattern Formation (Case in which Pattern “F” is Formed)

FIG. 9 shows a 300 mm Si substrate 51 which has been completed after the pattern transfer by the above-described flow with use of the replica template 41 according to the present embodiment.

FIG. 9 illustrates the case in which all shot patterns “F” are formed by the pattern area 5801 of the replica template 41. In other words, the Si substrate 51 shown in FIG. 9 exemplifies the case in which it is determined in the above-described step ST24 that the number of times of transfer has not exceeded the specified number and only the shot pattern “F” of the pattern formation area S801 has been transferred to desired pattern positions on the Si substrate 51 by the number of times corresponding to the number of shot patterns.

FIG. 9 illustrates, by way of example, the case in which all patterns “F” have been transferred to the Si substrate 51. All patterns may be transferred by only the pattern area S801 or S804 in the replica template 41, or may be transferred by the combination of the pattern areas 5801 and 5804.

Si Substrate after Pattern Formation (Case in which Pattern “A” is Formed)

FIG. 10 shows a 300 mm Si substrate 51 which has been completed after the pattern transfer by the above-described flow with use of the replica template 41 according to the present embodiment.

FIG. 10 illustrates the case in which all shot patterns “A” are formed by the pattern area 5802 of the replica template 41. In other words, the Si substrate 51 shown in FIG. 10 exemplifies the case in which it is determined in the above-described step ST29 that the number of times of transfer has not exceeded the specified number and only the shot pattern “A” of the pattern formation area S802 has been transferred to desired pattern positions on the Si substrate 51 by the number of times corresponding to the number of shot patterns.

FIG. 10 illustrates, by way of example, the case in which all patterns “A” have been transferred to the Si substrate 51. All patterns may be transferred by only the pattern area 5802 or 5803 in the replica template 41, or may be transferred by the combination of the pattern areas S802 and S803.

Needless to say, different design patterns “F” and “A” may be transferred at a time in a mixed fashion. The number of patterns (areas), which are formed on the glass substrate 51 with the diameter of 300 mm may be any number, if the conditions for the template 41 are met and the entire pattern falls within the range of the substrate 51. In addition, the patterns, which are disposed in the template 51, may be a plurality of identical patterns, or different kinds of patterns.

In the second embodiment, as described above, the single template 41 shown in FIG. 7 is used and the transfer pattern is selected and transferred (ST24, ST29). Thereby, the Si substrate 51, in which a plurality of patterns shown in FIG. 9 or FIG. 10 are disposed, can be manufactured.

### <Advantageous Effects>

As has been described above, according to the pattern forming method and pattern forming device of the second embodiment, at least the above-described advantageous effects (1) and (2) can be obtained.

Moreover, the replica template 41 according to the present embodiment differs from the replica template of the first embodiment in that a plurality of different design patterns “A (≠F)” are further disposed in the pattern areas S802 and S803 on the template 41.

Thus, with only the single template 41, the transfer pattern is selected and transferred (ST24, ST29). Thereby, the Si substrate 51, in which a plurality of patterns are disposed as shown in FIG. 9 and FIG. 10, can be manufactured at a time. Where necessary, a plurality of patterns “F” or “A” can be formed by the single template 41.

As a result, the manufacturing cost can advantageously be reduced in that the efficiency of the template 41 can be enhanced and the cost for forming the template 41 can be reduced.

### Comparative Example

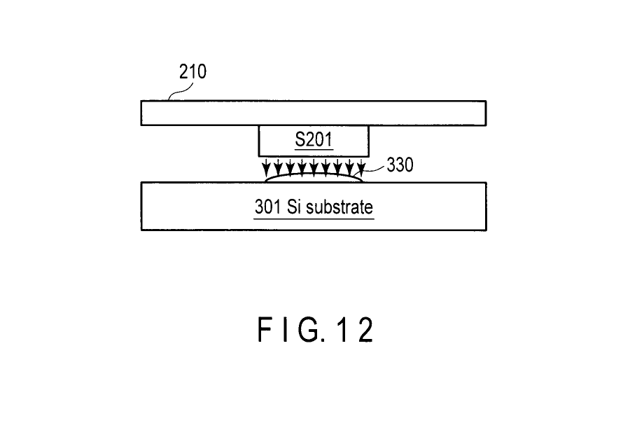

Next, referring to FIG. 11 and FIG. 12, a pattern forming method according to a comparative example is described for the purpose of comparison with the first and second embodiments. A detailed description of the parts, which are common to the parts in the first and second embodiments, is omitted.

### <Replica Template>

Referring to FIG. 11, a replica template 210 according to the comparative example is described.

As shown in FIG. 11, the replica template 210 according to the comparative example differs from the above-described embodiments in that the replica template 210 according to the comparative example is formed on a 6-inch glass substrate. In addition, the replica template 210 according to the comparative example differs from the first and second embodiments in that a pattern is formed by only a single pattern area 5201 in which a pattern (“F”) having a ratio in size of 1:1 to a pattern that is formed on the Si substrate is formed.

### <Pattern Forming Method>

Next, referring to FIG. 12, a description is given of a pattern forming method according to the comparative example of an imprint system, which uses the template 210 shown in FIG. 11.

As shown in FIG. 12, a Si substrate 310 that is a to-be-processed substrate is aligned with the template 210 such that the Si substrate 310 is disposed just under the pattern area 5201 of the template 210. Thereafter, the pattern area 5201 is pressed on a resin 330 of the Si substrate 310. Thereby, the shot pattern “F” of the pattern area 5201 is transferred to the pattern formation area on the Si substrate 310.

However, in the case where some problem, such as contamination or a flaw on the pattern, has occurred on the template 210 during the use of the replica template 210, or before or after the use of the replica template 210, it becomes impossible to continuously use this template 210. As a result, it becomes necessary to replace this template with another template, and a response time (hereinafter referred to as TAT (turn around time) degrades disadvantageously.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern forming method comprising:
transferring a first pattern area of a plurality of pattern areas to a to-be-processed substrate, by using a template on which the plurality of pattern areas, where patterns are formed on a substrate, are disposed;
counting up a number of times of transfer of the first pattern area, and storing the number of times of transfer;
determining whether the stored number of times of transfer of the pattern of the first pattern area has exceeded a specified number; and
executing switching to a second pattern of the plurality of pattern areas when it is determined, at a time of the determining, that the stored number of times of transfer of the pattern of the first pattern area has exceeded the specified number, and transferring the second pattern area to the to-be-processed substrate.

2. The method of claim 1, wherein the substrate on which the template is formed is a glass substrate.

3. The method of claim 1, further comprising selecting the first pattern area when it is determined, at a time of the determining, that the stored number of times of transfer of the pattern of the first pattern area has not exceeded the specified number, and transferring the first pattern area to the to-be-processed substrate by a number corresponding to a number of patterns which are to be transferred to the to-be-processed substrate.

4. The method of claim 1, further comprising determining whether a pattern which is to be transferred is a first pattern or not, prior to transferring the first pattern to the to-be-processed substrate, by using a template on which a plurality of pattern areas, where at least the first pattern and a second pattern that are different from each other are formed on the substrate, are disposed.

5. A pattern forming device comprising:
a transfer module configured to transfer a first pattern area of a plurality of pattern areas to a to-be-processed substrate, by using a template on which the plurality of pattern areas, where patterns are formed on a substrate, are disposed;
a storage module configured to store a number of times of transfer of the first pattern area;
a determination module configured to determine whether the stored number of times of transfer of the pattern of the first pattern area has exceeded a specified number; and
a control module configured to control the transfer module in a manner to execute switching to a second pattern of the plurality of pattern areas when the stored number of times of transfer of the pattern of the first pattern area has exceeded the specified number, and to transfer the second pattern area to the to-be-processed substrate.

6. The device of claim 5, wherein the substrate on which the template is formed is a glass substrate.

7. The device of claim 5, wherein the determination module is configured to select the first pattern area when it is determined that the stored number of times of transfer of the pattern of the first pattern area has not exceeded the specified number, and to transfer the first pattern area to the to-be-processed substrate by a number corresponding to a number of patterns which are to be transferred to the to-be-processed substrate.

8. The device of claim 5, wherein the substrate on which the template is formed is a template on which a plurality of pattern areas, where at least a first pattern and a second pattern that are different from each other are formed, are disposed.

9. The device of claim 8, wherein the determination module is configured to determine whether a pattern which is to be transferred is the first pattern or not, prior to transferring the first pattern to the to-be-processed substrate, by using the template on which the plurality of pattern areas, where at least the first pattern and the second pattern that are different from each other are formed on the substrate, are disposed.

10. A computer readable medium with a program which is executable by a computer in a pattern forming device, the computer program controlling the computer to execute functions of:
a transfer module configured to transfer a first pattern area of a plurality of pattern areas to a to-be-processed substrate, by using a template on which the plurality of pattern areas, where patterns are formed on a substrate, are disposed;
a storage module configured to store a number of times of transfer of the first pattern area;
a determination module configured to determine whether the stored number of times of transfer of the pattern of the first pattern area has exceeded a specified number; and
a control module configured to control the transfer module in a manner to execute switching to a second pattern of the plurality of pattern areas when the stored number of times of transfer of the pattern of the first pattern area has exceeded the specified number, and to transfer the second pattern area to the to-be-processed substrate.

11. The medium of claim 10, wherein the substrate on which the template is formed is a glass substrate.

12. The medium of claim 10, wherein the determination module is configured to select the first pattern area when it is determined that the stored number of times of transfer of the pattern of the first pattern area has not exceeded the specified number, and to transfer the first pattern area to the to-be-processed substrate by a number corresponding to a number of patterns which are to be transferred to the to-be-processed substrate.

13. The medium of claim 10, wherein the substrate on which the template is formed is a template on which a plurality of pattern areas, where at least a first pattern and a second pattern that are different from each other are formed, are disposed.

14. The medium of claim 13, wherein the determination module is configured to determine whether a pattern which is to be transferred is the first pattern or not, prior to transferring the first pattern to the to-be-processed substrate, by using the template on which the plurality of pattern areas, where at least the first pattern and the second pattern that are different from each other are formed on the substrate, are disposed.
